(19) United States
(12) Patent Application Publication
(10) Pub. No.: US 2006/0266192 A1
(43) Pub. Date: Nov. 30, 2006

(54) Roller Cutter and embosser for fondant and other foodstuffs

(76) Inventor: Catherine Franczyk, Woodridge, IL (US)

Correspondence Address: PATENT GROUP;ATTN: J. KENNETH JOUNG, DLA PIPER RUDNICK GRAY CARY US LLP, 203 N. LASALLE ST., SUITE 1900, CHICAGO, IL, 60601, US

(21) Appl. No.: 11/415,912

(22) Filed: May 1, 2006

Related U.S. Application Data
(60) Provisional application No. 60/676,633, filed on Apr. 29, 2005.

(51) Int. Cl. B26D 1/00

(52) U.S. Cl. 83/651

(57) ABSTRACT

A roller for cutting and/or embossing foodstuffs includes a handle and an extrusion rotatably mounted to the handle. A variety of annular attachments may be removably positioned on the extrusion. The annular attachments cut and/or emboss foodstuffs when the roller is rolled over the foodstuffs.

### CLAIM OF PRIORITY

This application claims priority to U.S. Provisional Patent Application No. 60/676,633, filed Apr. 29, 2005.

### FIELD OF THE INVENTION

The present invention relates generally to tools for cooking and baking and, more particularly, to a roller for cutting and forming embossed ribbons of fondant and other foodstuffs.

### BRIEF DESCRIPTION OF THE DRAWINGS

FIG. 1 is a top plan view of the handle of an embodiment of the roller of the present invention;

FIG. 2 is a top plan view of the extrusion of an embodiment of the roller of the present invention;

FIG. 3 is an end elevational view of the extrusion of FIG. 2;

FIG. 4 is a top plan view of the handle of FIG. 1 and the extrusion of FIGS. 2 and 3 in the assembled configuration;

FIG. 5 is a perspective view of a straight cutter wheel assembly capable of being mounted on the extrusion of FIGS. 2-4;

FIGS. 6A and 6B are perspective and side elevational views, respectively, of a zig-zag cutter wheel assembly capable of being mounted on the extrusion of FIGS. 2-4;

FIGS. 7A and 7B are perspective and side elevational views, respectively, of a wave cutter wheel assembly capable of being mounted on the extrusion of FIGS. 2-4;

FIG. 8 is a top plan view of a spacer sleeve having a first width and capable of being mounted on the extrusion of FIGS. 2-4;

FIG. 9 is a side elevational view of the spacer sleeve of FIG. 8;

FIG. 10 is a top plan view of a spacer sleeve having a second width and capable of being mounted on the extrusion of FIGS. 2-4;

FIG. 11 is a top plan view of a spacer sleeve having a third width and capable of being mounted on the extrusion of FIGS. 2-4;

FIG. 12 is a top plan view of a spacer sleeve having a fourth width and capable of being mounted on the extrusion of FIGS. 2-4;

FIG. 13 is a top plan view of a beeding sleeve capable of being mounted on the extrusion of FIGS. 2-4;

FIG. 14 is a side elevational view of the beeding sleeve of FIG. 13;

FIG. 15 is a striped pattern sleeve having a first width and capable of being mounted on the extrusion of FIGS. 2-4;

FIG. 16 is a striped pattern sleeve having a second width and capable of being mounted on the extrusion of FIGS. 2-4; and

FIG. 17 is a top plan view of the roller of FIG. 4 with straight cutter wheels and spacer, beeding and striped pattern sleeves positioned the extrusion so multiple embossed ribbons of fondant or other foodstuff may be made simultaneously.

### DETAILED DESCRIPTION OF EMBODIMENTS

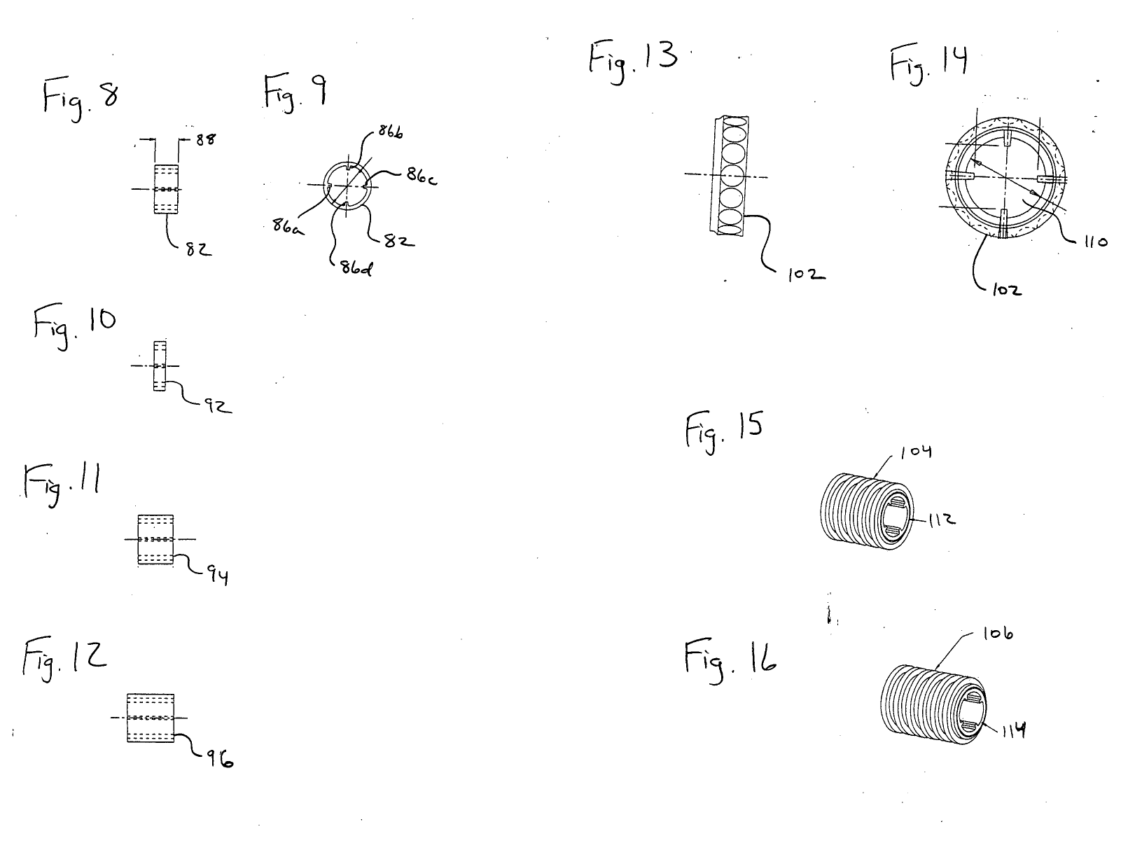

An embodiment of the roller cutter and embosser of the present invention is described below in FIGS. 1-17. The roller may be used cutting and forming embossed ribbons of fondant and the like for use in decorating cakes and other desert items. While the roller of the invention is described below in terms of use with fondant, it may also be used to cut and form embossed ribbons of other foodstuffs.

The roller features a handle, indicated in general at 20 in FIG. 1. The handle features a core portion, indicated in phantom at 22 in FIG. 1, an axle portion 24 and a joining portion 26 joining the two. A grip 32, preferably formed of plastic, is secured to the core portion so that it is generally perpendicular to the axle 24. The handle may be attached to the core by screws (34a and 34b in FIG. 1). Alternatively, rivets, adhesive or any other known fastening means may be used. The handle preferably is made of plastic. The core, axle and joining portions are preferably constructed from steel wire. A pair of collars 36a and 36b are positioned on axle portion 24. One end of axle 24 is threaded and receives wing nut 38. Collar 36a may be removed from axle 24 when wing nut 38 is loosened and removed from axle 24.

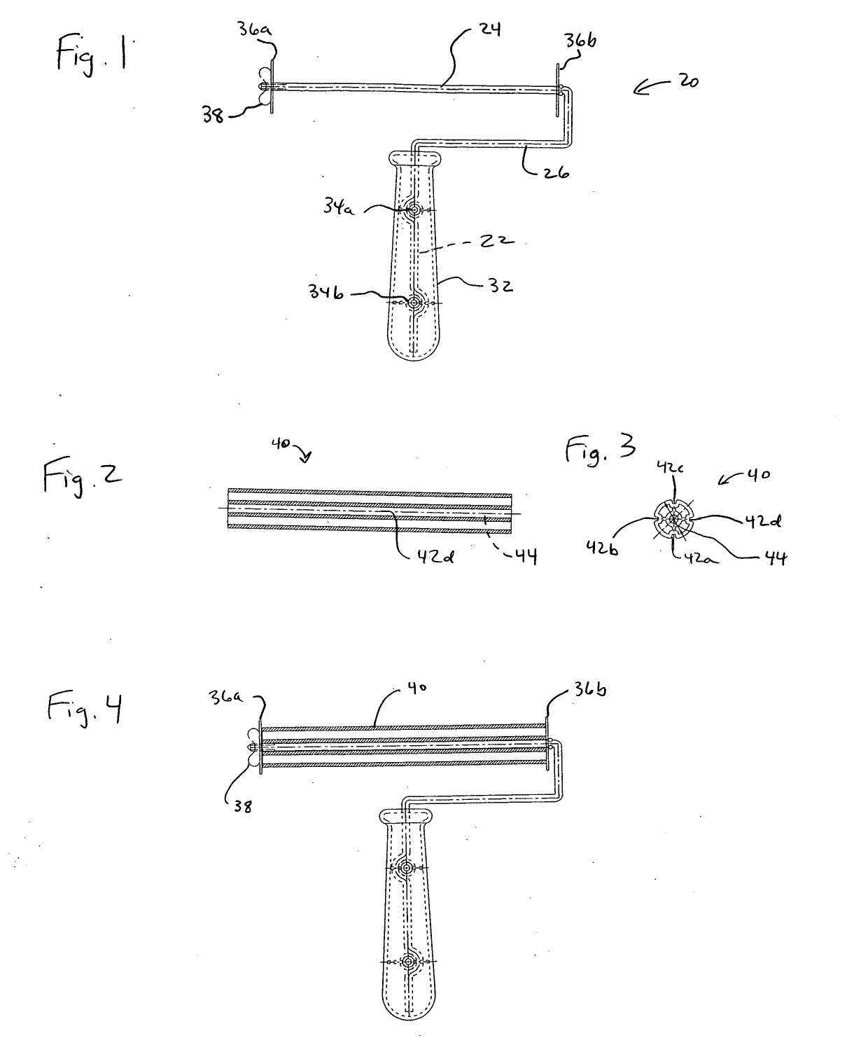

The roller also features an extrusion indicated in general at 40 in FIGS. 2 and 3. The extrusion is generally cylindrical and features four longitudinal grooves 42a-42d and a longitudinal central opening 44. While four longitudinal grooves are illustrated, the extrusion may feature an alternative number of longitudinal grooves. The extrusion preferably is constructed of plastic.

As illustrated in FIG. 4 the extrusion is mounted on the handle with axle 24 (FIG. 1) positioned through the longitudinal central opening 44 (FIGS. 2 and 3) of the extrusion. The wing nut 38 and collar 36a are removed prior to installation of the extrusion and then replaced when the extrusion is mounted on the handle so that the collars 36a and 36b hold the extrusion in place. The opening 44 is sized so that the extrusion 40 rotates freely on the axle portion 24 of the handle. As will be explained in greater detail below, a variety of annular attachments in the form of cutter wheels and sleeves for spacing and embossing may be positioned over the extrusion 40 of FIGS. 2-4.

A straight cutter wheel assembly for mounting on the extrusion of FIGS. 2-4 is indicated in general at 50 in FIG. 5. The assembly includes a straight cutter wheel 52 and a corresponding pair of retaining rings 54a and 54b. The straight cutter wheel 52 and retaining rings 54a and 54b each features a central bore. Each bore is sized to receive the extrusion of the roller with the bores of retaining rings 54a and 54b preferably equipped with four inward-facing and equal-spaced tabs 56a-d and 58a-d, respectively, that engage the grooves of the extrusion (42a-42d of FIGS. 2 and 3). As a result, the cutter wheel 52 may be slid onto the extrusion and locked into place with retaining rings 54a and 54b. The cutter wheel 52 is preferably made of a metal such as stainless steel and the retaining rings 54a and 54b are preferably made of plastic.

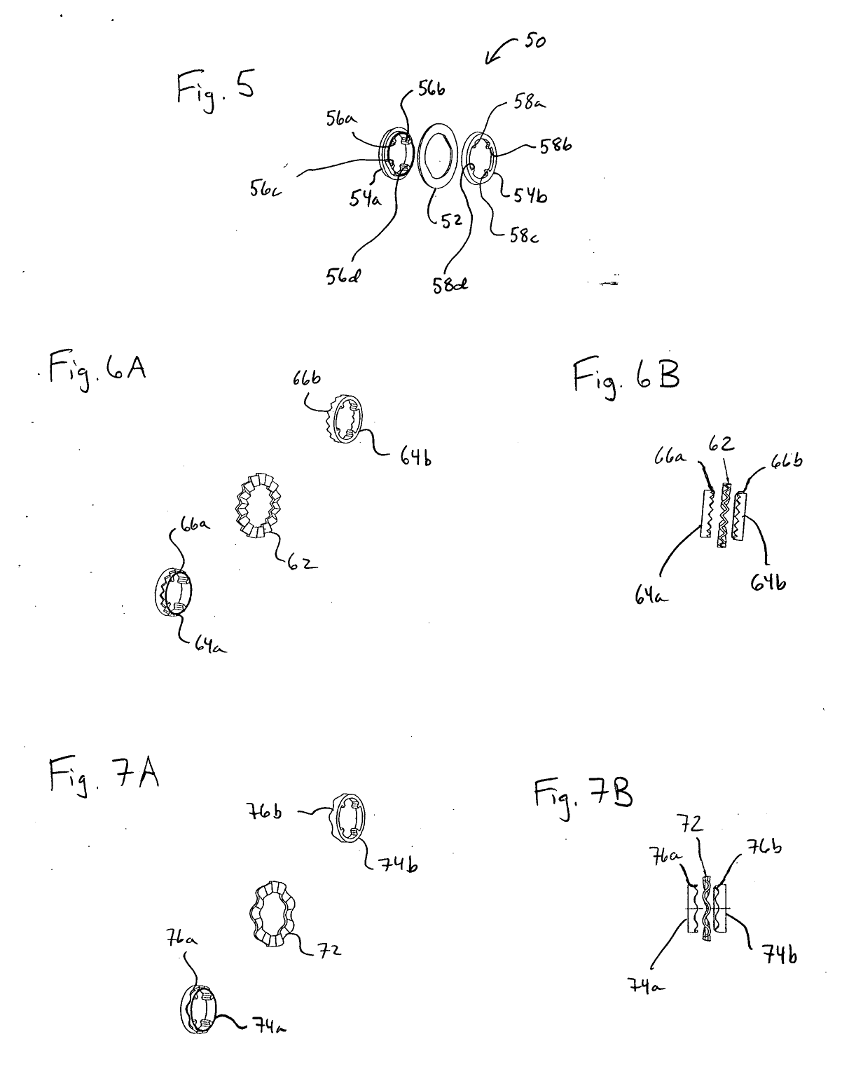

FIGS. 6A and 6B illustrate a zig-zag cutter wheel assembly that includes zig-zag cutter wheel 62 and retaining rings 64a and 64b. As with the straight cutter wheel assembly, the zig-zag cutter wheel 62 and retaining rings 64a and 64b each features a central bore. Each bore is sized to receive the extrusion of the roller with the bores of retaining rings 64a and 64b preferably equipped with four inward-facing and equal-spaced tabs so that they may be positioned on the extrusion (40 of FIGS. 2-4) with the zig-zag cutter wheel locked there between. Retaining rings 64a and 64b include zig-zag edges 66a and 66b, respectively, that engage opposing sides of the zig-zag cutter wheel 62 so that the cutter wheel is held securely in place on the extrusion. The cutter wheel 62 is preferably made of a metal such as stainless steel and the retaining rings 64a and 64b are preferably made of plastic.

FIGS. 7A and 7B illustrate a wave cutter wheel assembly that includes wave cutter wheel 72 and retaining rings 74a and 74b. As with the straight and zig-zag cutter wheel assemblies, the wave cutter wheel 72 and retaining rings 74a and 74b each features a central bore. Each bore is sized to receive the extrusion of the roller with the bores of retaining rings 74a and 74b preferably equipped with four inward-facing and equal-spaced tabs so that they may be positioned on the extrusion (40 of FIGS. 2-4) with the wave cutter wheel locked there between. Retaining rings 74a and 74b include wave edges 76a and 76b, respectively, that engage opposing sides of the wave cutter wheel 72 so that the cutter wheel is held securely in place on the extrusion. The cutter wheel 72 is preferably made of a metal such as stainless steel and the retaining rings 74a and 74b are preferably made of plastic.

A pair of straight cutter blades mounted on the extrusion will form a ribbon of fondant having straight longitudinal edges when the roller is rolled over a flattened layer of fondant. Similarly, a pair of zig-zag cutter blades mounted on the extrusion will form a ribbon of fondant having zig-zag edges and a pair of wave cutter blades mounted on the extrusion will form a ribbon of fondant having wave edges when the roller is rolled over a flattened layer of fondant. Of course, the blades may be combined to form a ribbon having different edge shapes (such as a ribbon having a straight edge and an opposing zig-zag edge).

A cylindrical spacer sleeve, indicated at 82 in FIGS. 8 and 9, features a central bore preferably equipped with four inward-facing and equal-spaced tabs 86a-d that engage the grooves of the extrusion (42a-42d of FIGS. 2 and 3). As a result, the spacer 82 may be slid onto the extrusion so as to establish desired spacing between a pair of cutter wheels (and/or the patterned sleeves described below). The spacer sleeve 82 features a width 88. As illustrated in FIGS. 10-12, spacer sleeves 92, 94 and 96 featuring alternative widths may be provided.

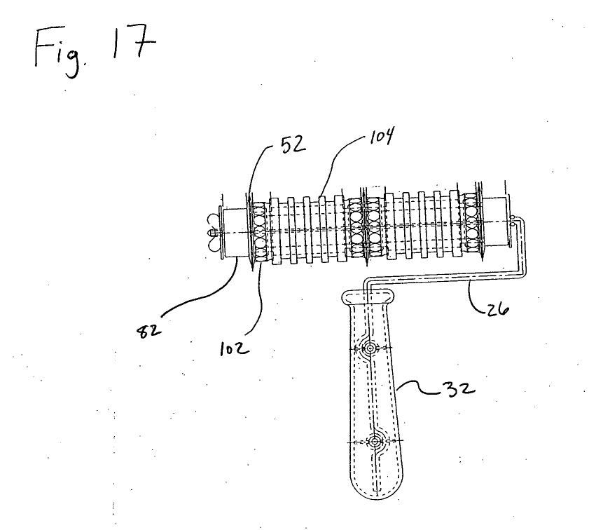

One or more embossing sleeves may positioned between a pair of cutter blades on the extrusion so that one or more patterns are imprinted or embossed on the ribbon that is formed by the cutter blades. The patterns may include semispherical (beeding) indentations via the beeding sleeve illustrated at 102 in FIGS. 13 and 14 or striped via the striped pattern sleeves illustrated at 104 and 106, respectively, in FIGS. 15 and 16. As indicated at 110 in FIG. 14 and 112 and 114 in FIGS. 15 and 16, respectively, each sleeve features a central bore preferably equipped with four inward-facing and equal-spaced tabs that engage the grooves of the extrusion (42a-42d of FIGS. 2 and 3) so that the sleeves may be slid onto the extrusion between a pair of cutter wheels.

As illustrated in FIG. 17, a number of the cutter wheels and spacer and embossing sleeves of FIGS. 5-16 may be positioned on the extrusion 40 of FIGS. 2-4 in an alternating fashion so that a number of embossed ribbons may be formed at once by the roller of the present invention. In the illustrated embodiment, the cutter wheels and spacer and embossing sleeves are positioned on the extrusion before it is positioned on the handle so that the handle collars (36a and 36b in FIG. 1) prevent the cutter wheels and spacer and embossing sleeves from sliding off of the extrusion. Virtually any combination of the cutter wheels and spacer and embossing sleeves of FIGS. 5-16 may be positioned on the extrusion of FIGS. 2-4 so that the roller of the present invention provides great flexibility. In addition, the invention is not limited to the patterns illustrated on cutter wheels and embossing sleeves of FIGS. 5-16.

While embodiments of the invention have been shown and described, it will be apparent to those skilled in the art that changes and modifications may be made therein without departing from the spirit of the invention.

What is claimed is:

1. A roller for cutting and/or embossing foodstuffs comprising:
a) a handle;
b) an extrusion rotatably mounted to the handle; and
c) a plurality of annular attachments positioned on said extrusion, said annular attachments cutting and/or embossing foodstuffs when the roller is rolled over the foodstuffs.

2. The roller of claim 1 wherein the extrusion includes a longitudinal groove.

3. The roller of claim 2 wherein each of the plurality of annular attachments includes a central bore with an inward-facing tab sized to engage the longitudinal groove of the extrusion.

4. The roller of claim 1 wherein the extrusion is removable from the handle.

5. The roller of claim 1 wherein the annular attachments include a cutter wheel.

6. The roller of claim 5 wherein the annular attachments include a cutter wheel assembly including a cutter wheel and a corresponding pair of retainer rings.

7. The roller of claim 6 wherein the cutter wheel is a zig-zag cutter wheel.

8. The roller of claim 6 wherein the cutter wheel is a wave cutter wheel.

9. The roller of claim 1 wherein the annular attachments include sleeves.

10. The roller of claim 9 wherein the sleeves include spacer sleeves.

11. The roller of claim 9 wherein the sleeves include embossing sleeves.

12. The roller of claim 11 wherein the embossing sleeves include beeding sleeves.

13. The roller of claim 11 wherein the embossing sleeves include striped pattern sleeves.

14. The roller of claim 1 wherein the handle includes an axle portion and a grip.

15. The roller of claim 14 wherein the extrusion includes a longitudinal central opening that receives the axle portion of the handle where the longitudinal central opening is sized so that said extrusion rotates on said axle.

16. The roller of claim 15 wherein the axle includes a threaded portion that is engaged by a nut.

17. The roller of claim 15 wherein the handle includes a pair of collars positioned at opposing ends of the extrusion.

18. The roller of claim 17 wherein one of said pair of collars is removable from said handle.

19. A roller for cutting and/or embossing foodstuffs comprising:
a) a handle;
b) an extrusion;
c) means for rotatably mounting the extrusion to the handle;
d) a plurality of annular attachments; and
e) means for mounting the plurality of annular attachments to the extrusion.

20. The roller of claim 19 wherein said plurality of annular attachments include cutter wheels and embossing sleeves.
